(19) United States
(12) Patent Application Publication
(10) Pub. No.: US 2026/0083094 A1
(43) Pub. Date: Mar. 26, 2026

(54) VERTICAL SURFACE PLACED PRODUCT WITH A MAGNETIC OR FERROMAGNETIC ELEMENT IN A BASE OF THE PRODUCT

(71) Applicant: Tatiana Nikolaevna MOSALOVA, Moscow (RU)

(72) Inventor: Tatiana Nikolaevna MOSALOVA, Moscow (RU)

(21) Appl. No.: 19/086,699

(22) Filed: Mar. 21, 2025

(30) Foreign Application Priority Data
Sep. 23, 2024 (RU) 2024128074

(51) Int. Cl. A01K 15/02; F16M 13/02

(52) U.S. Cl. CPC A01K 15/024; F16M 13/02

(57) ABSTRACT

The proposed invention relates to household items, more specifically to brackets for placing a product or device on a vertical surface, and can be used in everyday life. A product with a base with a magnetic or ferromagnetic element placed on a vertical surface is proposed. The technical result achieved by implementing the claimed invention, in addition to the invention realizing its purpose, is the elimination of the disadvantages of analogs and thus ensuring the rapid disconnection of the bracket and the product or device placed on it, while ensuring the usual reliability of placing the product or device on a vertical surface. Another technical result is the expansion of the arsenal of technical means-brackets for products and devices.

### FIELD OF INVENTION

The proposed invention relates to household items, particularly to brackets for placement of devices or products on a vertical surface, and can be used in everyday life.

### DESCRIPTION OF THE RELATED ART

There are various known brackets and holders used for many various purposes, such as, for example, shelf brackets (see https://www.ozon.ru/category/kronshteyn-dlya-polok/), TV brackets (https://www.ozon.ru/category/kronshteyny-dlya-televizorov-15529/), holders for planters (https://www.ozon.ru/category/tsvety-i-rasteniya-14884) and other similar means for placing products and devices on a vertical surface.

A common disadvantage of conventional means is that it is impossible to quickly disconnect the device or product placed onto a bracket from the bracket itself, for example, for replacement, maintenance, power source replacement or recharging.

Therefore, there is a need in the field for a quick way of disconnecting a device or a product from a bracket they were placed on.

The present invention is proposed for thew first time.

### SUMMARY OF THE INVENTION

The technical problem to be solved by the claimed invention is to create brackets, and/or systems, and/or sets, and/or products, and/or devices created for the first time that do not possess the drawbacks of the prior art and enable the bracket to be quickly disconnected from the device or product that is placed on it. Another technical problem to be solved by the claimed invention is to expand the technical means, namely brackets for devices and products that are placed on a vertical surface.

The objective of the proposed invention, in addition to it performing its functions, is to eliminate the drawbacks of the prior art and thus to enable the bracket to be quickly disconnected from the device or product that is placed on it while maintaining the usual security of device or product placement on a vertical surface. Another objective of the proposed invention is to expand the technical means, namely brackets for devices and products.

The objective of the present invention is achieved by a product that is placed on a vertical surface, the product comprising a base with a recess and a main part, wherein the recess contains an opposite magnetic or ferromagnetic element adapted to create a magnetic coupling with a corresponding magnetic and/or ferromagnetic element of a bracket; wherein the bracket is an element that is fixed to a vertical surface to form a ledge, adapted to place the ledge into a recess provided in the base of the product, the base faces the vertical surface; wherein the ledge comprises at least one magnetic or ferromagnetic element, and the recess comprises a corresponding opposite magnetic or ferromagnetic element, so that said opposite element contacts the corresponding magnetic or ferromagnetic element of the bracket to create a magnetic coupling when the ledge is placed into the recess; wherein the recess is designed, so as to provide a shift of the opposite magnetic or ferromagnetic element relative to the magnetic of ferromagnetic element of the bracket; and wherein the main part of the product is selected, so as not to break said magnetic coupling during operation due to its weight.

### BRIEF DESCRIPTION OF THE DRAWINGS

Exemplary embodiments of the present invention are described in further detail below with references made to the attached drawings, included herein by reference:

FIG. 1 illustrates an exemplary, non-limiting, embodiment of the proposed bracket 100.

FIG. 2 illustrates an exemplary, non-limiting, embodiment of product 200 that is connected to bracket 100.

FIG. 3 illustrates a different exemplary, non-limiting, embodiment of product 200 that is connected to bracket 100.

FIG. 4 illustrates exemplary, non-limiting, options of connecting bracket 100 and product 200.

FIG. 5 illustrates an exemplary, non-limiting, way of placing bracket 100 in recess 202 of product 200.

FIG. 6 illustrates a different exemplary, non-limiting, embodiment of the proposed bracket 100.

FIG. 7 illustrates an exemplary, non-limiting, embodiment of product 200 that is connected to bracket 100 according to the second embodiment.

FIG. 8 illustrates an exemplary, non-limiting, embodiment of shifting ferromagnetic element 201 (not shown in this drawing) relative to magnetic element 101 in one embodiment of product 200 when using bracket 100 according to the second embodiment.

FIG. 9 illustrates an exemplary, non-limiting, embodiment of shifting ferromagnetic element 201 (not shown in this drawing) relative to magnetic element 101 in another embodiment of product 200 when using bracket 100 according to the second embodiment.

FIG. 10 illustrates an exemplary, non-limiting, rear view of two exemplary embodiments of product 200 designed for use with bracket 100 according to the first embodiment.

FIG. 11 illustrates an exemplary, non-limiting, rear view of two exemplary embodiments of product 200 designed for use with bracket 100 according to the second embodiment.

### DETAILED DESCRIPTION OF THE PREFERRED EMBODIMENTS

According to a preferred embodiment of the present invention, there is provided a bracket for a product placed on a vertical surface, the bracket being an element that is fixed to a vertical surface to form a ledge, adapted to place the ledge into a recess provided in a side of the product that faces the vertical surface; wherein the ledge comprises at least one magnetic element, and the recess holds an opposite ferromagnetic element, so that said opposite element contacts the magnetic element to create a magnetic coupling when the ledge is placed into the recess; wherein the recess is designed, so as to provide a shift of the magnetic element relative to the ferromagnetic element.

According to an exemplary embodiment of the present invention, there is provided a bracket according to the present disclosure, characterized in that the product is a scratching post for animals.

According to an exemplary embodiment of the present invention, there is provided a bracket according to the present disclosure, characterized in that the product is a decorative element.

According to an exemplary embodiment of the present invention, there is provided a bracket according to the present disclosure, characterized in that the product is a frame for photos, paintings, or prints.

According to an exemplary embodiment of the present invention, there is provided a bracket according to the present disclosure, characterized in that the product is a flowerpot.

According to an exemplary embodiment of the present invention, there is provided a bracket according to the present disclosure, characterized in that the product is a wall game.

According to an exemplary embodiment of the present invention, there is provided a bracket according to the present disclosure, characterized in that both the ledge and the recess are adapted to provide a shift in a horizontal or vertical direction, or a shift by rotating the product around a central perpendicular vertical surface of the axis of the recess.

Additional alternative embodiments of the present invention are provided below. This disclosure is in no way limiting to the scope of protection granted by the present patent. Rather, it should be noted that the claimed invention can be implemented in different ways, so as to include different components and conditions, or combinations thereof, which are similar to the components and conditions disclosed herein, in combination with other existing and future technologies.

FIG. 1 illustrates an exemplary, non-limiting, embodiment of the proposed bracket 100. Preferably, but not limited to, according to one embodiment, the proposed bracket 100 is a parallelepiped, one side of which faces a vertical surface 300, such as, for example, but not limited to, a building wall or a room wall, a post, etc., wherein surface 300 has enough space for secure placement of bracket 100 on surface 300. Furthermore, for example, but not limited to, bracket 100 can be fixed to surface 300 using any suitable method that is known now or will be known in the future, which provides a sufficiently secure connection between bracket 100 and surface 300, such as, for example, but not limited to, threaded connection, such as, for example, but not limited to, anchor, and/or threaded, and/or screw connection, as well as, but not limited to, glued connection, welded connection, etc. In addition, for example, but not limited to, in case surface 300 is made of a ferromagnetic material or has a ferromagnetic area, the back side of bracket 100 can be equipped with an additional magnetic element (not shown in the drawing) for secure connection with a ferromagnetic surface 300 or a ferromagnetic area thereof. For example, but not limited to, a ferromagnetic area on surface 300 can be made of a soft iron patch (magnetic wallpaper) or the like. Furthermore, but not limited to, in order to fix bracket 100 to surface 300 by means of anchor or threaded connection, surface 300 can be equipped with corresponding holes through which bracket 100 can be fixed to surface 300 by means of a screw, including a self-tapping screw. In case welded connection is used, bracket 100 is, for example, but not limited to, made of metal or at least contains a metallic base (not shown in the drawing) of sufficient thickness that is suitable for forming a welded joint with a metallic surface 300 or a metallic area on surface 300. In case glued connection is used, bracket 100 has, for example, but not limited to, an adhesive base on its back side (not shown in the drawing), such as, for example, but not limited to, a double-sided adhesive tape, whereas surface 300 is chosen, so that sufficient adhesion of the adhesive surface of the tape to surface 300 is provided.

Furthermore, but not limited to, bracket 100 can be made of a material or has a base made of a material (not shown in the drawing), which has similar adhesive properties to the glue that is used to glue bracket 100 to surface 300. Therefore, but not limited to, bracket 100 can be fixed 300 using any suitable method that is known now or will be known in the future and therefore will not be described in detail below. Furthermore, it should be generally noted that, when fixed to surface 300, bracket 100 always forms a ledge. Furthermore, but not limited to, the ledge can be formed either directly by the body of bracket 100 or by any protruding part of said body (not shown in the figure). Furthermore, preferably, but not limited to, bracket 100 comprises, and therefore the formed ledge comprises too, at least one magnetic element 101, which is the main magnetic element of bracket 100. Preferably, but not limited to, magnetic element 101 does not occupy the entire surface of the ledge, but is placed in such a way, so as to provide secure magnetic coupling with the opposite ferromagnetic element 201 in recess 202 of product 200, which will be described in more detail below, while maintaining a possibility of shifting ferromagnetic element 201 against magnetic element 101 in order to quickly and conveniently decouple them from each other. Furthermore, but not limited to, it is mainly determined by the fact that tensile strength of a magnetic coupling is much higher than its shear strength, which is especially relevant in case magnetic element 101 is a powerful magnet, such as, for example, but not limited to, a neodymium magnet, which will inevitably require shifting for decoupling.

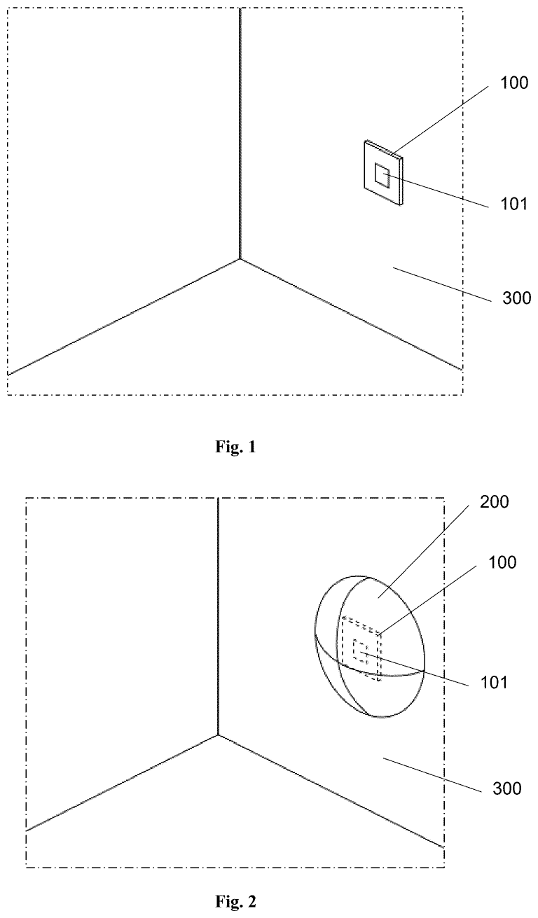

FIG. 2 illustrates an exemplary, non-limiting, embodiment of product 200 that is connected to bracket 100. Preferably, but not limited to, such product 200 can be predominantly of any suitable shape or size, which are mainly determined by the strength and reliability of the magnetic coupling provided, as well as by the strength and reliability of connection between bracket 100 and surface 300. Furthermore, but not limited to, in this embodiment, product 200 is not predominantly flat, i.e., at least the thickness of its part that protrudes over the ledge formed by bracket 100 is at least twice the distance of the ledge from surface 300. Furthermore, but not limited to, the shape of product 200 is mainly determined by its purpose.

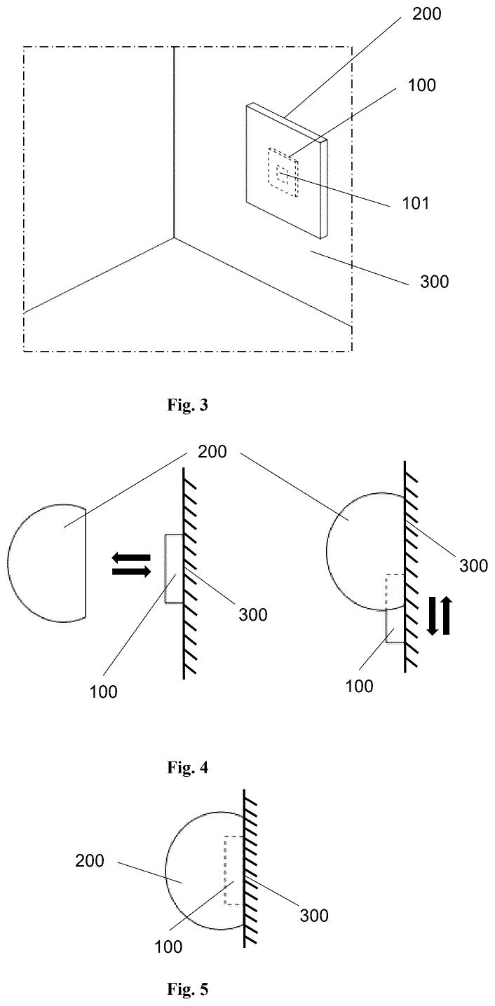

FIG. 3 illustrates a different exemplary, non-limiting, embodiment of product 200 that is connected to bracket 100. Preferably, but not limited to, in this different embodiment, product 200 is predominantly flat, i.e., at least the thickness of its part that protrudes over the ledge formed by bracket 100 is at less than twice the distance of the ledge from surface 300. Furthermore, but not limited to, the shape of product 200 is also mainly determined by its purpose.

FIG. 4 illustrates exemplary, non-limiting, options of connecting bracket 100 and product 200. As will be shown below, product 200 may comprise recess 202, which can accommodate the ledge formed by bracket 100. Furthermore, but not limited to, it is generally possible to provide two connection options. According to the first option, but not limited to, as shown in the left part of FIG. 4, recess 202 of product 200 is slid onto the ledge formed by bracket 100 in horizontal direction toward surface 300; wherein, therefore, recess 202 in product 200 is designed, so that it has walls on all sides, thus not allowing product 200 to shift against bracket 100 in any direction. Therefore, but not limited to, in order to disconnect product 200 from bracket 100, one needs at least to turn product 200 along an axis perpendicular to surface 300, as will be shown below, thereby performing said shift. According to the second option, but not limited to, as shown in the right part of FIG. 4, recess 202 of product 200 is slid onto the ledge formed by bracket 100 in horizontal or vertical direction parallel to surface 300; wherein, therefore, recess 202 in product 200 is designed, so that it has walls on all sides but one, thus allowing product 200 to shift against bracket 100 in the direction of the missing wall. Therefore, but not limited to, in order to disconnect product 200 from bracket 100, one needs at least to slide product 200 in the direction opposite to the missing wall, i.e., if recess 202 does not have a bottom wall, then product 200 should be slid upwards, etc., thereby performing said shift. FIG. 5 illustrates an exemplary, non-limiting, way of placing bracket 100 in recess 202 of product 200. At the same time, but not limited to, although it is not shown in the drawing, it should be obvious to a person having ordinary skill in the art that the back wall of product 200 itself does not necessarily have to contain recess 202, since there may be provided a base in product 200 that will contain a suitable recess 202.

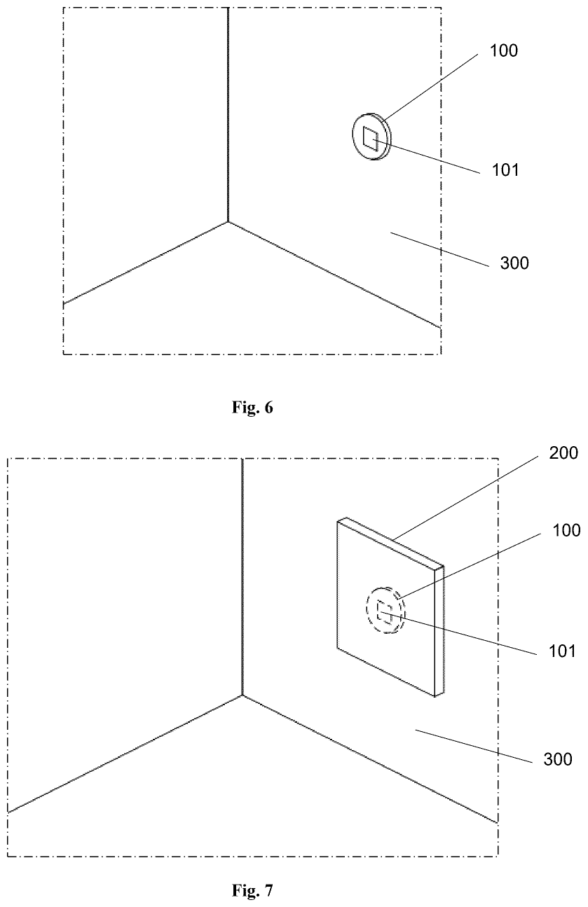

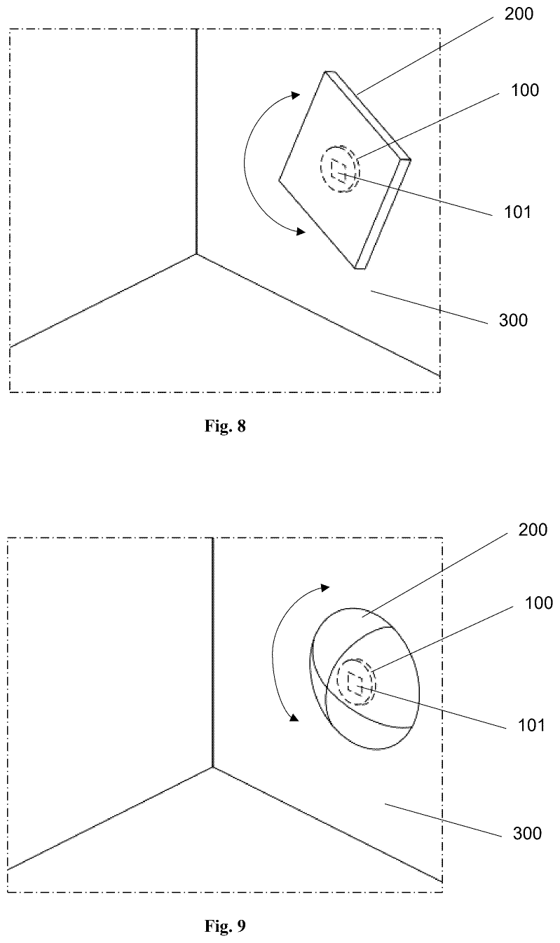

At the same time, it should be obvious to a person having ordinary skill in the art that when recess 202 has the same shape and size as bracket 100, and bracket 100 has corners, then it will be difficult or even impossible to shift product 200 by turning it. FIG. 6 illustrates a different exemplary, non-limiting, embodiment of the proposed bracket 100. In contrast to the ones disclosed above with reference to FIG. 1, the embodiment of bracket 100 with reference to FIG. 6 is at least not made in the form of a rectangle, as was shown with reference to FIG. 1. Such bracket 100 according to FIG. 6 is connected with product 200 in the same way as was shown with reference to FIG. 5 (left side) and has almost the same functionality except the fact that its shape and size are chosen, so that recess 202 can be rotated around the ledge formed by bracket 100. Furthermore, but not limited to, such bracket 100 can be additionally equipped with a positioning means, for example, a small-sized recess in the surface of bracket 100, into which an opposite small-sized ledge can fit, which is provided on the surface of recess 202 that touches the surface of bracket 100 (not shown in the drawing). This positioning means can be used for exact placement of product 200 relative to surface 300. FIG. 7 illustrates an exemplary, non-limiting, embodiment of a predominantly flat product 200 that is connected to bracket 100 according to FIG. 6. FIG. 8 illustrates an exemplary, non-limiting, embodiment of shifting metallic element 201 (not shown in this drawing) relative to magnetic element 101 in product 200 with reference to FIG. 7 when using bracket 100 according to FIG. 6. FIG. 9 illustrates an exemplary, non-limiting, embodiment of shifting ferromagnetic element 201 (not shown in this drawing) relative to magnetic element 101 in another embodiment of product 200 when using bracket 100 according to FIG. 6.

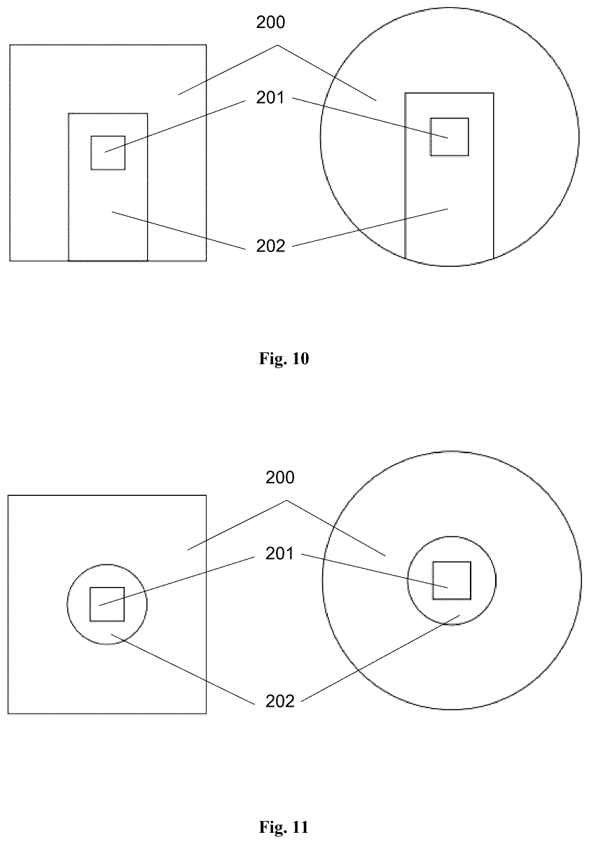

FIG. 10 illustrates an exemplary, non-limiting, rear view of two exemplary embodiments of product 200 designed for use with bracket 100 according to FIG. 1. Furthermore, but not limited to, as was mentioned above, the shape of product 200 is not essential, since it can be determined by the product's purpose, but at the same time, the back side of product 200 or the back side of the base of product 200 contains recess 202, which houses ferromagnetic element 201, which is the opposite element for magnetic element 101. Such recess 202, although the cut is not shown in the drawing, obviously, does not have one of the walls, thus enabling ferromagnetic element 201 at least shift in relation to magnetic element 101 in a horizontal or vertical direction parallel to surface 300. At the same time, it should be obvious to a person having ordinary skill in the art that in case the size of bracket 100 allows it, the elements can shift against each other by turning recess 202 around the ledge formed by bracket 100 as well. At the same time, it should be obvious to a person having ordinary skill in the art that product 200 can be placed onto two or more brackets 100, depending on the size of product 200, and it should be noted that such brackets 100 have to be positioned coaxially on surface 300, so that all ferromagnetic elements 201 shift simultaneously relative to all corresponding magnetic elements 101. FIG. 11 illustrates an exemplary, non-limiting, rear view of two exemplary embodiments of product 200 designed for use with bracket 100 according to the embodiment with reference to FIG. 6. In contrast to disclosed above with reference to FIG. 10, recesses 202, in this case, have walls on all sides and are essentially made in a round shape or another shape, so that ferromagnetic element 201 can shift relative to magnetic element 101 solely by rotating recess 202 around the ledge formed by bracket 100.

At the same time, it should be obvious to a person having ordinary skill in the art that magnetic element 101 and ferromagnetic element 201 can be switched, i.e., so that product 200 comprises magnetic element 101 and bracket 100 comprises ferromagnetic element 201, respectively. Moreover, but not limited to, product 200 can be provided with its own magnetic element, wherein bracket 100 still has magnetic element 101, and wherein said magnetic elements are unlike, thus attracting to each other, which can provide a more secure coupling than a magneto-ferromagnetic coupling.

For example, but not limited to, product 200 is a scratching post for animals 200. Most typically, but not limited to, a scratching post for cats has a base with a scratching panel designed in such a way as to gradually wear out under the claws of an animal, such as, for example, a Maine Coon cat. Most typically, the scratching material is a slowly wearing material, such as, but not limited to, jute rope, cotton rope, sisal, carpet, or cardboard. A common drawback of conventional scratching posts is that they are not easily replaceable and that it is impossible to just replace the scratching material. Also, as a rule, a scratching post has to be fixed to the wall exclusively by using screws and anchors. Furthermore, but not limited to, it should be noted that the animal uses the scratching post by stretching and moving its claws downwards along the surface to which scratching post 200 is fixed. Therefore, it is necessary to ensure a reliable connection between scratching post 200 and bracket 100, including situations, where the animal tries to move the scratching post down. For this purpose, but not limited to, recess 202 of scratching post 200 either has all walls or misses only the bottom or one of the side walls, which is due to the need to prevent ferromagnetic element 201 from shifting relative to magnetic element 101. Furthermore, when suitable magnets and ferromagnetic materials are used to fix scratching post 200 to bracket 100, secure connection with enough tensile strength is ensured, and in case the material of scratching post 200 wears out, the scratching post can be easily replaced with a new one by quickly and easily disconnecting the old scracther. Furthermore, scratching post 200 can be of any suitable shape, as was disclosed above; in addition, but not limited to, when the scratching post is not predominantly flat, as was mentioned above, then it nevertheless comprises a base with recess 202, which can accommodate the ledge formed by bracket 100.

Therefore, there may also be provided a set including at least any bracket 100 disclosed above and at least any product 200 disclosed above. In this case, preferably, the set comprises one bracket 100 disclosed herein and several replaceable products 200 disclosed herein.

The present disclosure of the claimed invention demonstrates only certain exemplary embodiments of the invention, which by no means limit the scope of the claimed invention, meaning that it may be embodied in alternative forms that do not go beyond the scope of the present disclosure and which may be obvious to persons having ordinary skill in the art.

1. A product that is placed on a vertical surface, the product comprising a base with a recess and a main part, wherein the recess contains an opposite magnetic or ferromagnetic element adapted to create a magnetic coupling with a corresponding magnetic and/or ferromagnetic element of a bracket; wherein the bracket is an element that is fixed to a vertical surface to form a ledge, adapted to place the ledge into a recess provided in the base of the product, the base faces the vertical surface; wherein the ledge comprises at least one magnetic or ferromagnetic element, and the recess comprises a corresponding opposite magnetic or ferromagnetic element, so that said opposite element contacts the corresponding magnetic or ferromagnetic element of the bracket to create a magnetic coupling when the ledge is placed into the recess; wherein the recess is designed, so as to provide a shift of the opposite magnetic or ferromagnetic element relative to the magnetic of ferromagnetic element of the bracket; and wherein the main part of the product is selected, so as not to break said magnetic coupling during operation due to its weight.
